(19) United States
(12) Patent Application Publication
(10) Pub. No.: US 2012/0212008 A1
(43) Pub. Date: Aug. 23, 2012

(54) VEHICLE CAB

(76) Inventor: Dalibor Kanovsky, Stare Mesto (CZ)

(21) Appl. No.: 13/181,348

(22) Filed: Jul. 12, 2011

(30) Foreign Application Priority Data
Feb. 21, 2011 (CZ) CZ2011-23952 U

(51) Int. Cl. B62D 33/06

(52) U.S. Cl. 296/190.1

(57) ABSTRACT

A vehicle cab using a chassis frame's fastening spots for fastening a glazed front part, roof part, rear part and, where applicable, lefthand and righthand openable doors. The front part is made of safety glass and fastened to the frame by holders, and made of a bottom hold-down front steel bar containing position stops for door locks. The openable doors are situated on hinges fastened on a steel base fastened to the protective frame. The rear part is fastened on its sides to the protective frame using fastening screws and, fastened in its bottom portion by a rear hold-down steel bar. The top portion of the rear part is connected with screws to the roof part. The openable doors are optically divided by reinforcing steel elements in their bottom and top portions. The top portions contain a glazed window fastened in a window profile having a fixed and sliding portion.

### CROSS-REFERENCE TO RELATED APPLICATION

This application claims the benefit of the priority filing date of Czech Republic utility patent no. CZ2011-23952 U filed on Feb. 21, 2011 in the name of DFK Cab, s.r.o.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to a vehicle cab, in particular, an off-road vehicle cab, and to the fastening of its front, roof, and rear parts, and its doors, to the original protective frame of the chassis.

The well-known cabs of off-road vehicles (hereinafter referred to as UTV) consist of a front part, a roof part, a rear part and an openable door. The front part is glazed and provided with a squeegee (and a windshield cleaner as needed). It is fastened to the protective UTV frame using individual holders, locks, or by means of a sheetmetal frame at the glass perimeter. The roof part is made of hard polyethylene or sheetmetal with the possibility of placing a roof window when ventilation is desired, and is fastened to the protection UTV frame by means of screws or locks. Also known are UTV frames where the roof part is made of a soft PVC foil fastened to the protective UTV frame using fastening tapes. The rear part is fixed or openable and is made either of safety glass or soft PVC foil. The rear part is made of safety glass and usually fastened to the protective UTV frame using holders, locks or sheetmetal frame at the perimeter of the protective frame of the vehicle chassis. The rear part of the soft PVC foil is provided with a looking hole for the driver and is fastened to the protective frame using fastening tapes. The openable door is made either of hard polyethylene or sheetmetal with glazing for the looking hole of the driver to the left or to the right. When the openable door is made of sheetmetal with glazing, it is fastened to the protective UTV frame using screws or locks. The openable door may be provided with a window capable of opening for ventilation, with a key lock, and with a gas strut for easy opening. The openable door is made of soft PVC foil and is fastened to the protective UTV frame by means of fastening tapes.

The drawback of cabs made of a combination of glass and sheetmetal is their excessive weight which increases the consumption of fuel and reduces the stability of the UTV on rugged terrain. The glass is frequently broken and the price of such cabs is excessively high, including their spare parts. The drawback of cabs with the polyethylene panels is their low material impact strength and their high sensitivity to scratching. The drawback of cabs with soft PVC panels is their insufficient protection against cold, insufficient protection against penetration by others, and wrinkling of the foil with frequently rolling in the summer (causing reduced transparency when repeatedly used).

According to the U.S. Pat. No. 7,845,711 (WO 2008/127590), a removable vehicle cab is well-known, in which the individual cab parts are fastened to the vehicle frame using special clip-on locks. The use of this method of fastening cab parts to the vehicle frame is undoubtedly quick, but special clip-on locks are used, this method of fastening is rather expensive.

### SUMMARY

The present invention to a large extent removes drawbacks of cabs of existing off-road vehicles, making use of fastening spots on the original protective frame of a vehicle chassis for fastening the glazed front part, roof part, and rear part, and lefthand and righthand openable doors, where applicable. The principle of the given technical solution is that the glazed front part is made of safety glass and is fastened to the protective frame by means of holders and a bottom front hold-down steel bar. This bottom hold-down steel bar also contains position stops for the door locks of the lefthand openable door and the righthand openable door. The lefthand openable door is situated on hinges fastened on the lefthand steel base and righthand openable door. The lefthand openable door is situated on hinges fastened on the righthand steel base where the lefthand steel base and the righthand steel base are fastened to the protective frame of the vehicle chassis. The rear part is fastened on its sides to the protective frame by means of fastening screws and, in its bottom portion, by means of a rear hold-on steel bar. The rear part is connected on its top with the roof part. The lefthand openable door and the righthand openable door are optically divided by a reinforcing steel element in their bottom and top parts. The top part contains a glazed window fastened in the window profile, where the window consists of a fixed part and of a sliding part.

According to the first embodiment of the invention, the roof part consists of sheetmetal or of a polycarbonate sheet with a hardened surface. The rear part consists of a polycarbonate sheet with a hardened surface or consists of safety glass. It is constructed as a fixed or openable part.

From the point of view of the door weight, it is suitable to fill up the bottom part of the openable door with a polycarbonate sheet with a hardened surface or, for increasing its resistance, with steel sheetmetal. The fixed part of the glazed window contains a polycarbonate sheet with a hardened surface or a safety glass; the sliding part thereof is made of a safety glass.

According to another embodiment of the invention, the window profile of the door consists of three ribs, where the outer rib contains an extended part which reaches the bottom part of the lefthand or righthand openable doors, and where, between the extended part of the window profile and the reinforcing element of the door, there is a polycarbonate sheet or a sheetmetal attached.

The merits of this invention consist of a quick and easy fastening of individual vehicle cab parts on respective fastening spots—points of the original protective frame of a vehicle chassis, without needing complicated locks or fastening elements. As a result of the materials listed in the first and second claims, other merits are identified, namely, a lighter weight of the vehicle cab, resistance to surface scratching, a longer service life of individual cab parts, protection of the cab, and the entire vehicle, against unauthorized use.

### BRIEF DESCRIPTION OF THE DRAWINGS

The exemplary design of the UTV cab is represented in the drawings, where

FIG. 1 illustrates a perspective view of the cab from the front and lefthand openable door

FIG. 2 shows a rear view of the cab and the lefthand openable door

FIG. 3 indicates the position of the reinforcing element on the lefthand openable door

FIG. 4 shows a window profile of plastic or aluminum

FIG. 5 shows the position of the glass windows and the polycarbonate sheet in the window profile

### DETAILED DESCRIPTION OF THE INVENTION

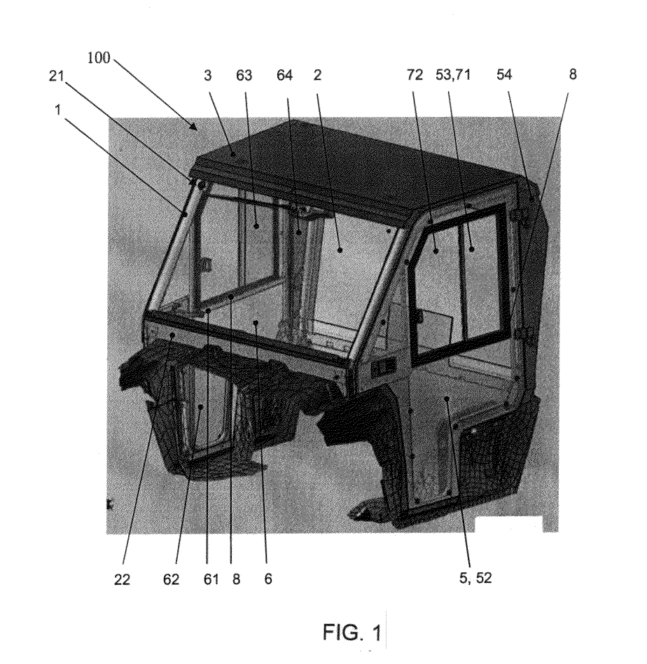

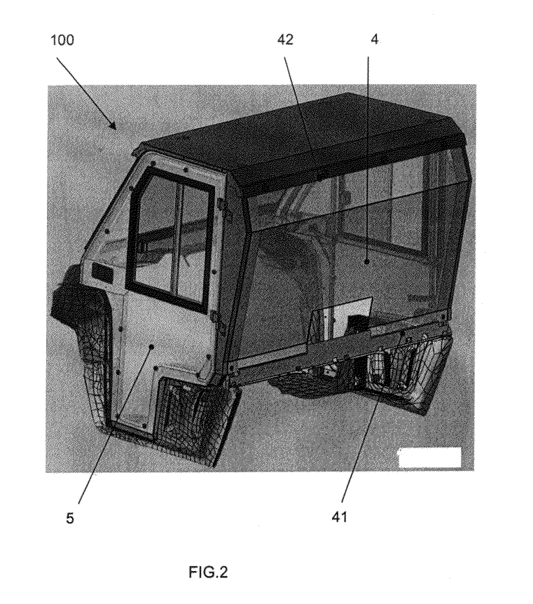

The cab 100 of the UTV vehicle according to FIGS. 1 and 2 makes use of the original protective frame 1 of the vehicle chassis, on the existing fastening spots of which the individual parts are attached, namely, the front glazed part 2, the roof part 3, the rear part 4, and the lefthand openable door 5 and righthand openable door 6 where applicable.

The glazed front part 2 is made of safety glass and is fastened to the protective frame 1 by means of holders 21 and bottom front hold-down steel bar 22. The base 54 for fastening the righthand openable door 5 and the base 64 for fastening the righthand openable door 6 are fastened on their sides to the protective frame 1 through the existing fastening spots. Both bases 54 and 64 are made of steel sheetmetal and contain door hinges for attaching the lefthand openable door 5 and the righthand openable door 6. Door position stops are mounted on the bottom front hold-down steel bar 22 for the door locks of the lefthand openable door 5 and righthand openable door 6.

The roof part 3 is fastened on the protective frame 1 through existing fastening spots by means of fastening screws. The roof part 3 is made of either steel sheetmetal or of polycarbonate sheet having a scratch-resistant surface.

The rear part 4 is made of either polycarbonate sheet with a hardened surface resistant to scratching or safety glass. The rear part 4 is fastened on its sides to the original protective frame 1 by means of screws which are screwed into the existing fastening spots of the protective frame 1. In its bottom rear portion, the rear part 4 is fastened to the protective frame 1 by means of a rear hold-down steel bar 41. The rear part 4 is fastened on its top portion to the roof part 3 by means of screws 42. The rear part 4 may be fixed or openable.

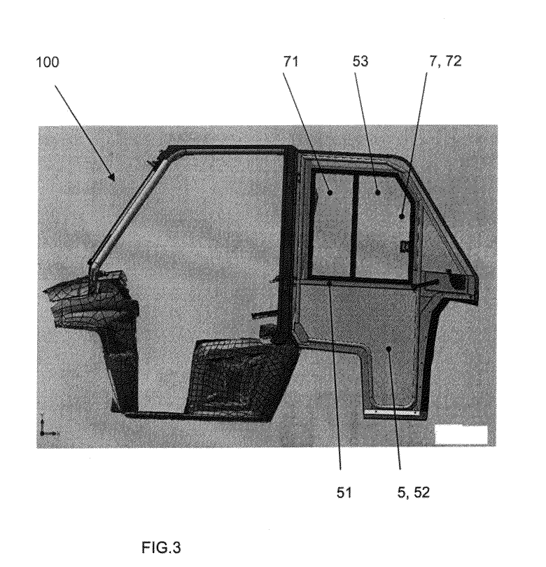

The lefthand openable door 5 contains a central reinforcing element 51 and the righthand openable door 6 contains a central reinforcing element 61 (FIGS. 1 and 3). The reinforcing element 51 divides the lefthand openable door 5 in its bottom portion 52 and top portion 53. The reinforcing element 61 divides the righthand door 6 in its bottom portion 62 and top portion 63. The bottom portions 52 and 62 are filled up with either a polycarbonate sheet with a hardened surface resistant to scratching, or steel sheetmetal.

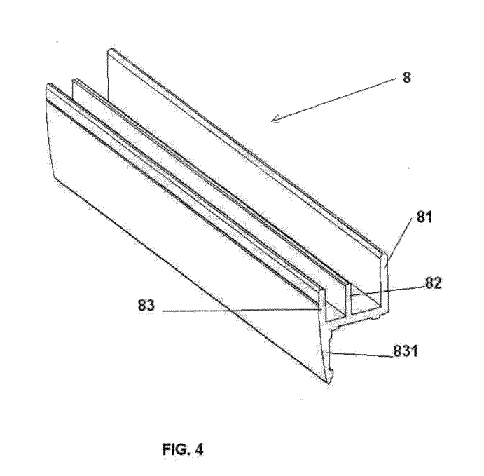

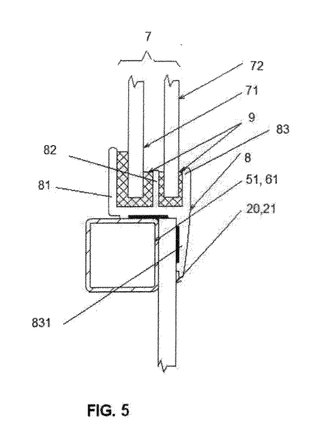

The top portions 53, 63 contain an openable glazed window 7 fastened in a window profile 8. The window 7 is composed of a fixed portion 71 made of either a polycarbonate sheet with a hardened surface resistant to scratching, or a safety glass, and composed of a sliding portion 72 made of safety glass. The window profile 8 is made of aluminum or plastics. The window profile 8 (FIGS. 4, 5) consists of three ribs 81, 82 and 83, where the outer rib 83 contains an extended portion 831 that reaches up to the bottom portions 52 and 62 of the lefthand openable door 5 and righthand openable door 6. Between the extended portion 831 and the reinforcing elements 51, 61 the polycarbonate sheet 20 with a hardened surface resistant to scratching, or the steel sheetmetal 21, is attached. The rubber packing 9 (FIG. 5) is placed between the glasses 71, 72 (FIG. 5).

What is claimed is:

1. A vehicle cab making use of the fastening spots of the original protective frame 1 of a vehicle chassis for fastening a glazed front part 2, a roof part 3, a rear part 4, and, if the vehicle cab contains them, a lefthand openable door 5 and righthand openable door 6, characterized by the fact that
the glazed front part 2 is made of safety glass and is fastened to the protective frame 1 by means of holders 21 and made of a bottom front hold-down steel bar 22,
where the bottom front hold-down steel bar 22 also contains position stops for door locks of the lefthand openable door 5 and righthand openable door 6,
where the lefthand openable door is situated on hinges fastened on a lefthand steel base 54 and where the righthand openable door 6 is situated on hinges fastened on a righthand steel base 64,
where the lefthand steel base 54 and the righthand steel base 64 are fastened to the protective frame 1,
the rear part 4 is fastened on its sides to the protective frame 1 using fastening screws and, in its bottom portion, using a rear hold-down steel bar 41,
in its top portion, the rear part 4 is connected by means of screws 42 to the roof part 3,
the lefthand openable door 5 and the righthand openable door 6 are optically divided by means of reinforcing steel elements 51, 61 in its bottom portion 52, 62 and top portion 53, 63,
where the top portion contains a glazed window 7 fastened in a window profile 8, and
where the window 7 consists of a fixed portion 71 and a sliding portion 72.

2. The vehicle cab acording to th claim 1 characterized by the fact that the roof part 3 consists of either a steel sheetmetal or a polycarbonate sheet with hardened surface, the rear part 4 consists of either a steel sheetmetal or polycarbonate sheet with hardened surface or consists of safety glass, where this portion is made as a fixed or openable component, where the bottom portions 52, 62 of the openable doors 5, 6 are filled up with a polycarbonate sheet with a hardened surface or with steel sheetmetal, the fixed portion 71 of the glazed window 7 contains either a polycarbonate sheet with a hardened surface or a safety glass, the sliding portion 72 being made of safety glass.

3. The vehicle cab according to the claim 1 characterized by the fact that the window profile 8 consists of three ribs 81, 82 and 83, where the outer rib 83 contains an extended portion 831 which reaches the bottom portions 52 and 62 of the lefthand openable door 5, and righthand openable door, respectively, where a polycarbonate sheet 20 or a steel sheetmetal 21 are fastened between the extended portion 831 and the reinforcing elements 51 and 61.

4. The vehicle cab according to the claim 2 characterized by the fact that the window profile 8 consists of three ribs 81, 82 and 83, where the outer rib 83 contains an extended portion 831 which reaches the bottom portions 52 and 62 of the lefthand openable door 5, and righthand openable door, respectively, where a polycarbonate sheet 20 or a steel sheetmetal 21 are fastened between the extended portion 831 and the reinforcing elements 51 and 61.
